(19) United States
(12) Patent Application Publication
(10) Pub. No.: US 2020/0122382 A1
(43) Pub. Date: Apr. 23, 2020

(54) APPARATUS FOR FORMING RUBBER HOSE

(71) Applicant: HS R & A Co., Ltd., Gyeongsangnam-do (KR)

(72) Inventors: Jae Hyeok CHOI, Gyeongsangnam-do (KR); Deok Hyun LIM, Gyeongsangnam-do (KR); Young Jun KIM, Gyeongsangnam-do (KR); Jong Ik WOO, Busan (KR); Jae Won SIM, Gyeongsangnam-do (KR); Min Gyu PARK, Gyeongsangnam-do (KR)

(21) Appl. No.: 16/660,342

(22) Filed: Oct. 22, 2019

(30) Foreign Application Priority Data
Oct. 23, 2018 (KR) 10-2018-0126654

(51) Int. Cl. B29C 53/80; B29C 53/08

(52) U.S. Cl. CPC B29C 53/80; B29C 53/086

(57) ABSTRACT

A hose forming apparatus is provided that can separate with minimum shape deformation when separating a hose after forming is complete. The hose shaping apparatus includes an insertion path configured to insert a hose in a longitudinal direction and to have a shape corresponding to that of the hose to be formed; and a fixing portion configured to fix the hose inserted into the insertion path, wherein the insertion path forms a straight insertion portion configured to insert a straight segment of the hose to be formed and a bending insertion portion configured to insert a bending segment of the hose, and the bending insertion portion has an additional angle further bent by 15 to 35° than an angle of the bending segment.

### CROSS-REFERENCE TO RELATED APPLICATION(S)

This application is based on and claims priority under 35 U.S.C. 119 to Korean Patent Application No. 10-2018-0126654, filed on Oct. 23, 2018, in the Korean Intellectual Property Office, the disclosures of which are herein incorporated by reference in their entireties.

### BACKGROUND OF THE INVENTION

### Field of the Invention

The present disclosure relates to a rubber hose forming apparatus that can separate a hose with minimum shape deformation when separating the hose after forming of the hose is complete.

### Description of the Related Art

In general, rubber hoses are mainly used as fluid passages of engines, pneumatic equipment, and hydraulic equipment to be used in vehicles, ships, or industrial facilities.

Such a rubber hose forms a rubber layer at an outer surface and/or inner surface of a reinforcing layer made of high tensile fibers and is extruded linearly from an extruder.

Here, the rubber hose should be formed in a specific curved shape including a straight shape according to a use condition.

In order to process the rubber hose into a specific curved shape, an extruded straight rubber hose is cut in a predetermined length, is inserted into a curved mandrel mold, and is put and cured in a curing furnace at a high temperature and a high pressure, thereby having elasticity while having the same shape as a curved shape of the mandrel mold.

As illustrated in FIG. 1, a conventional rubber hose forming apparatus includes a mandrel mold 23 having each unit mandrel 23 that inserts a rubber hose 10 and a mold body 21 that connects the unit mandrel 23.

In the prior art, at one end of the unit mandrel 23, a mandrel coupling bolt 23a for coupling the unit mandrel 23 to the mold body 21 is provided, in the mold body 21, a bolt insertion hole 21a that inserts the mandrel coupling bolt 23a is formed, in a state in which the rubber hose 10 is fitted into the unit mandrel 23, a curing process is performed at least once in a curing kiln, and a cooling process is performed for a predetermined time after the curing process; thus, a rubber hose having the same shape as that of the unit mandrel is formed.

However, in the conventional rubber hose forming apparatus, after a cooling process, when separating the rubber hose in which forming is complete from the unit mandrel, deformation occurs in an initial forming state of the rubber hose; thus, there is a problem that a defective rate is high.

That is, in order to separate the rubber hose fitted to the unit mandrel, when the rubber hose is separated from the unit mandrel by pulling out from the upper end of the unit mandrel, the rubber hose in which forming is complete should be separated while passing through different bending portions of the unit mandrel; thus, an error occurs in a bending angle and there is a risk of damage of the rubber hose, thereby resulting in a failure.

### SUMMARY OF THE INVENTION

The present disclosure has been made in view of the above problem and provides a rubber hose forming apparatus capable of minimizing a defective rate of a rubber hose in which forming is complete by enabling the rubber hose to be integrally separated without passing through other bent portions of a unit mandrel when separating the rubber hose in which forming is complete.

In accordance with an aspect of the present disclosure, a hose shaping apparatus includes an insertion path configured to insert a hose in a longitudinal direction and to have a shape corresponding to that of the hose to be formed; and a fixing portion configured to fix the hose inserted into the insertion path, wherein the insertion path forms a straight insertion portion configured to insert a straight segment of the hose to be formed and a bending insertion portion configured to insert a bending segment of the hose, and the bending insertion portion has an additional angle further bent by 15 to 35° than an angle of the bending segment.

Preferably, an inner diameter of the straight insertion portion is larger by 1 to 5 mm than an outer diameter of the hose, and an inner diameter of the bending insertion portion is larger by 3 to 7 mm than an outer diameter of the hose.

Preferably, the fixing portion includes a first fixing member configured to fix the front end of the hose inserted into the insertion path and a second fixing member configured to fix the rear end of the hose.

Preferably, the first fixing member includes a fixing body fixed by a first setscrew provided at one end of the insertion path and in which one end of the hose is inserted in a fitting manner for shape matching, and a separation preventing piece formed in an upper portion of the insertion path to be adjacent to the fixing body and configured to support an outer surface of the hose inserted into the fixing body to prevent the hose from deviating when coupling the hose inserted into the fixing body to the second fixing member, wherein the second fixing member includes a penetration body fixed by a second setscrew provided at the other end of the insertion path and having a penetration hole having connected both ends, a moving body slidably inserted into the penetration hole and into which the other end of the hose is inserted in a fitting manner for shape matching, and a pressure screw configured to advance from an outer surface of the penetration body into the penetration hole so as to fix by a pressure an outer surface of the moving body inserted into the penetration body, and wherein the moving body further has at least one stopper to limit a moving distance of the moving body or to limit an insertion length of the hose inserted into the moving body.

Preferably, the fixing portion further includes an additional support member provided adjacent to each other in a longitudinal direction of the insertion path to support the hose together with the first fixing member and the second fixing member, and wherein the additional support member includes an installation piece fixedly installed in an upper portion of the insertion path, a lever rotatably coupled to the installation piece, and a support piece having a plate shape and configured to support an upper surface of the hose inserted into the insertion path by a rotation of the lever.

### BRIEF DESCRIPTION OF THE DRAWINGS

The objects, features, and advantages of the present disclosure will be more apparent from the following detailed description in conjunction with the accompanying drawings, in which:

FIG. 1 is a diagram illustrating a conventional rubber hose forming apparatus;

FIG. 2 is a diagram illustrating a hose forming apparatus according to an embodiment of the present disclosure;

FIG. 3 is a side view illustrating the hose forming apparatus of FIG. 2;

FIG. 4 is a diagram comparing shapes of a jig of a hose forming apparatus and a hose in which forming is complete according to an embodiment of the present disclosure;

FIG. 5 is a diagram illustrating a straight insertion portion and a curved insertion portion of a hose forming apparatus according to an embodiment of the present disclosure;

FIG. 6 is a diagram illustrating a fixing portion of a hose forming apparatus according to an embodiment of the present disclosure;

FIG. 7 is a diagram illustrating an additional support member of FIG. 6; and

FIGS. 8 to 11 are diagrams illustrating in order a hose mounting state using a hose forming apparatus according to an embodiment of the present disclosure.

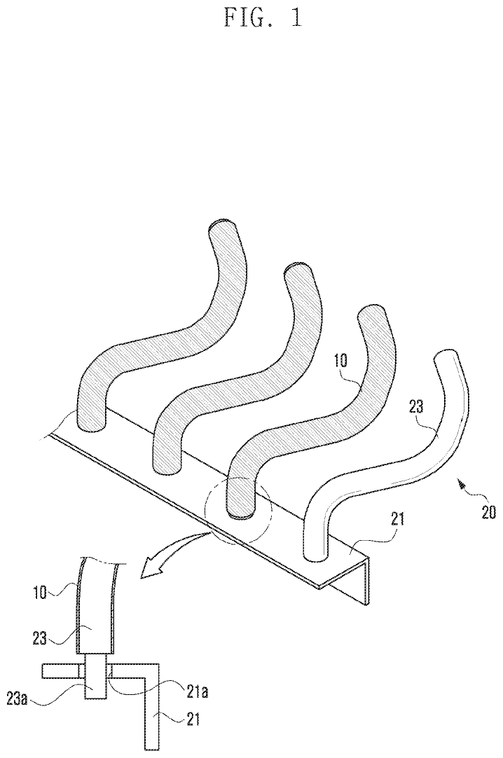

### DETAILED DESCRIPTION OF EMBODIMENTS

Hereinafter, a hose forming apparatus according to an embodiment of the present disclosure will be described in detail with reference to the accompanying drawings. Before describing the embodiment, in a hose forming apparatus 1 according to the present embodiment, in order to clearly describe the gist of the present disclosure, because a hose H to be formed has a hook shape having a plurality of straight segments (H-1) and bending segments (H-2), it is described that an insertion path 100 has a shape corresponding thereto, however this is only an embodiment and a shape of the straight segment (H-1) and the bending segment (H-2) may vary according to a shape of the hose H to be formed as needed.

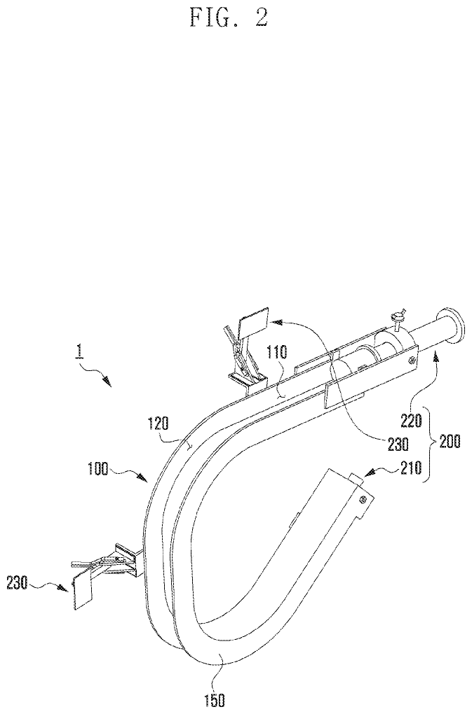

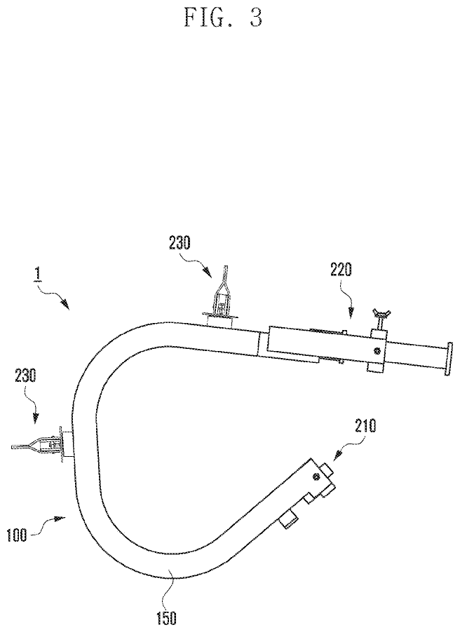

FIG. 2 is a diagram illustrating a hose forming apparatus according to the present disclosure, and FIG. 3 is a side view illustrating the hose forming apparatus of FIG. 2.

As illustrated in FIGS. 2 and 3, the hose forming apparatus 1 according to the present embodiment includes an insertion path 100 and a fixing portion 200, but a shape of the hose H in which forming is complete can be maintained by the insertion path 100 and the fixing portion 200; thus, satisfaction of a product can be enhanced, a defective rate can be remarkably reduced, and mass production can be performed; thus, a production speed can be improved.

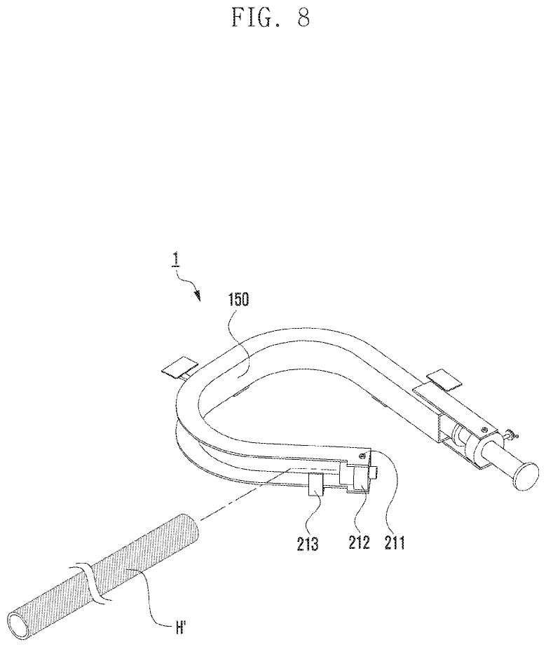

More specifically, the insertion path 100 is provided to form a hose H′ having a shape of ‘-’ before forming into an operator's desired hose shape and includes a straight insertion portion 110 and a bending insertion portion 120 (see FIG. 8).

As illustrated in the drawing, the insertion path 100 has a jig 150 of a predetermined length so as to have a shape corresponding to that of the hose H to be formed, and at the front end and the rear end of the insertion path 100, a first fixing member 210 and a second fixing member 220, respectively, to be described later are provided to fix the hose H inserted into the insertion path 100.

Both ends and an upper surface of the insertion path 100 are opened, and the insertion path 100 forms at least one straight insertion portion 110 and a bending insertion portion 120 to enable the hose H′ before forming to be inserted therein.

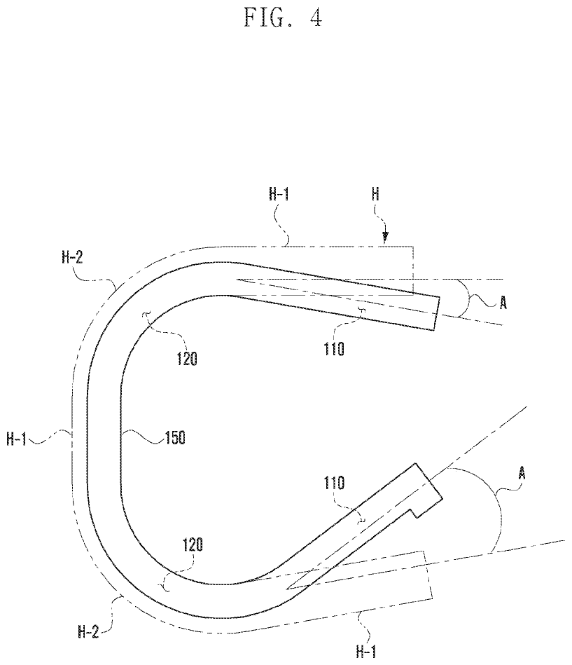

FIG. 4 is a diagram comparing shapes of a jig of a hose forming apparatus and a hose in which shaping has been completed according to the present disclosure.

With reference to FIG. 4, the straight insertion portion 110 and the bending insertion portion 120 formed in the insertion path 100 may be formed at a position corresponding to the straight segment (H-1) and the bending segment H-2 formed in the hose H after forming and it is preferable that an angle of the bending insertion portion 120 has an additional angle A further bent inward by about 15 to 35° than that of the bending segment (H-2).

That is, the hose H inserted into and fixed to the insertion path 100 performs a curing process of forming in a shape of the hose H to be formed by applying at least once a heat of a predetermined temperature and a cooling process of enabling the hose H to maintain a changed shape by cooling the hose H at a room temperature after the curing process is finished.

After such forming process steps are finished, when a predetermined time has elapsed, a spring back phenomenon occurs in which the hose H returns to an original shape before being formed, and in order to correspond to such a spring back phenomenon, by setting a bending angle of the bending insertion portion 120 to be further folded inward than that of the hose H after forming, even though an angle between the bending segment (H-2) of the hose H and the following straight segment (H-1) increases to a predetermined angle due to the spring back phenomenon, a bending angle to be maintained by the hose H after forming is maintained; thus, a defective rate can be minimized.

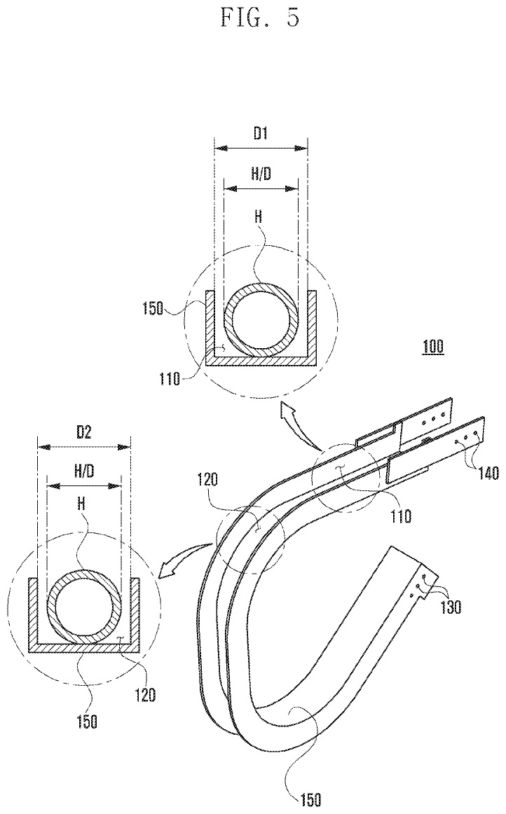

FIG. 5 is a diagram illustrating a straight insertion portion and a curved line insertion portion of a hose forming apparatus according to the present disclosure.

With reference to FIG. 5, an inner diameter D1 of the straight insertion portion 110 formed in the insertion path 100 is preferably formed larger by about 1 to 5 mm than an outer diameter H/D of the hose H inserted therein, and an inner diameter D2 of the bending insertion portion 120 is preferably formed larger by about 3 to 7 mm than the outer diameter of the hose H, and this is because when performing the above-described forming process steps, the bending insertion portion 120 is formed in consideration of workability of the inserted hose H, and the bending insertion portion 120 is formed to correspond to an expansion phenomenon of the hose H to be formed by a heat generated when performing the curing process.

The above-mentioned forming process step enables to have a shape of the hose H to be formed through a curing process for enabling the hose H to have a shape corresponding to that of the insertion path 100 through a first curing process of heating the hose H at 150-155° C. for about 25-30 minutes and a second curing process of heating the hose H at 175-180° C. for about 25-30 minutes after the first curing process and a cooling process of cooling the hose H in which the curing process is complete at a room temperature for about 5 to 10 minutes.

Here, a cleaning process of about 3 to 5 minutes may further occur between the curing process and the cooling process, and a total estimated time of a forming process step of completing one hose H with such forming is maximum 75 minutes; thus, the hose H can be formed more quickly than the conventional forming step and a defective rate can be minimized.

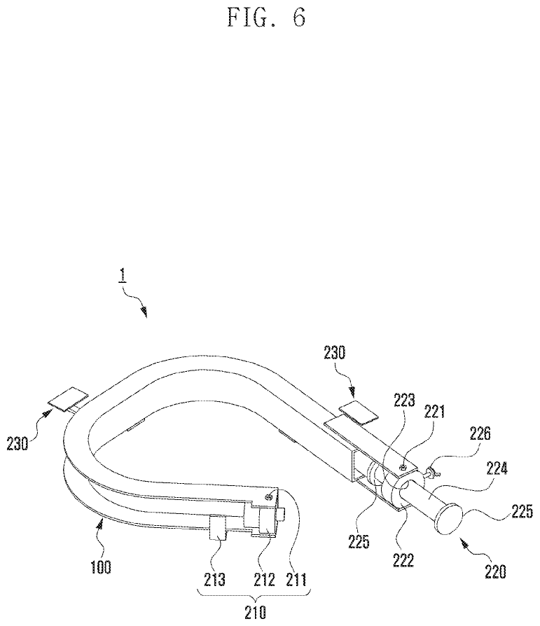

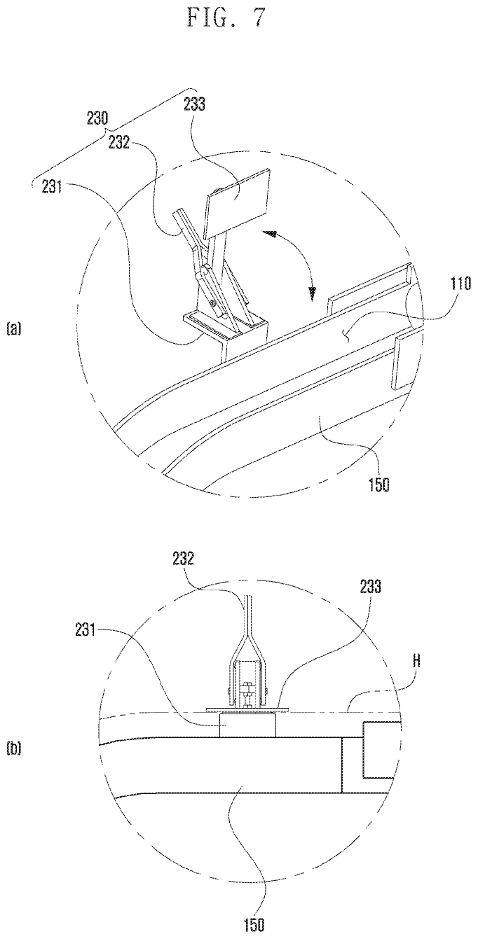

FIG. 6 is a diagram illustrating a fixing portion of a hose forming apparatus according to the present disclosure, and FIG. 7 is a diagram illustrating an additional support member of FIG. 6.

As illustrated in FIGS. 6 and 7, in order to fix and support the hose H inserted into the insertion path 100 but not to separate from the insertion path 100 at the forming process step, the fixing portion 200 includes a first fixing member 210 and a second fixing member 220.

As illustrated in FIG. 6, the first fixing member 210 is provided at the front end (or rear end) of the insertion path 100, has a structure that may insert and fix one end of the hose H inserted into the insertion path 100, and may include at least one of a first setscrew 211, a fixing body 212, and a separation preventing piece 213.

The first setscrew 211 may use a fastening means such as a conventional bolt or screw and be inserted into the front end of the insertion path 100 through a first adjusting hole 130 formed in an outer surface of the insertion path 100 to press an outer surface of the fixing body 212 or may be inserted for screw coupling at the inside of the insertion path 100 to fix the fixing body 212.

In this case, the first adjusting hole 130 may be adjacently formed in the plural at an outer surface of the insertion path 100 as needed to freely adjust disposition of the fixing body 212 fixed to the inside of the insertion path 100; thus, it is preferable that the first adjusting hole 130 has a corresponding structure according to a length of the inserted hose H (see FIG. 5).

The fixing body 212 is formed in a circular column shape having different diameters so that the fixing body 212 may be inserted into the tubular hose H by a predetermined length to enable one end of the hose H to be coupled in a fitting manner.

The fixing body 212 formed in a column shape has a hollow portion (not illustrated) in a longitudinal direction thereof, as needed; thus, before the hose H is inserted into the second fixing member 220 to be described later, the inside of the hose H is blown out by a pressure such as an air pressure, thereby removing a foreign matter.

The separation preventing piece 213 contacts and supports an outer surface of the hose H coupled in a fitting manner by the fixing body 212, i.e., an outer surface of the hose H exposed to the outside through an opened upper surface of the insertion path 100 to prevent the hose H from separating from the insertion path 100 when the hose after being coupled to the fixing body 212 is coupled to a moving body 224 of the second fixing member 220 in a fitting manner.

The separation preventing piece 213 may be bent to have entirely a shape ‘¬’, a lower portion thereof is fixed to an outer surface of the insertion path 100 by welding or the like, and an upper portion thereof is disposed to cross an opened upper portion of the insertion path 100 to support an outer surface of the hose H.

As illustrated in the drawing, the second fixing member 220 is provided at the rear end (or front end) of the insertion path 100 and has a structure to insert and fix the other end of the hose H coupled in a fitting manner by the first fixing member 210, and may include at least one of a second setscrew 221, a penetration body 222, a moving body 224, and a pressure screw 226.

The second setscrew 221 may use the same type fastening means as that of the first setscrew 211 and is inserted through a second adjustable hole 140 formed at an outer surface of the insertion path 100 to fix the penetration body 222.

The penetration body 222 has a ring shape so that the moving body 224 may slide easily therein, and the penetration body 222 may be inserted into the rear end of the insertion path 100 to be fixed to the insertion path 100 by the second setscrew 221.

The penetration body 222 has a structure that may be adjusted by the second setscrew 221 by freely moving from the rear end of the insertion path 100 by a plurality of second adjusting holes 140 formed adjacent to an outer surface of the insertion path 100 in the same manner as the fixing body 212 (see FIG. 5).

The moving body 224 is formed in a pillar shape of a predetermined length and is inserted to perform a reciprocation slide motion into a penetration hole 223 of the fixing body 212 having a ring shape.

In this case, at an outer surface of the moving body 224, a pair of stoppers 225 protrude adjacent to each other in a longitudinal direction, and it is preferable that one of the stoppers 225 limits an insertion length of the hose H inserted into the moving body 224 and that upon moving, the other one contacts the penetration body 222 to limit a moving distance of the moving body 224.

The pressure screw 226 is inserted through a tightening hole formed from an outer surface of the penetration body 222 to the penetration hole 223 and presses an outer surface of the moving body 224 inserted into the penetration hole 223 by tightening to fix to prevent a movement of the moving body 224 inserted into the hose H.

The pressure screw 226 uses a wing bolt that may be easily loosened or tightened by an operator, but at an outer surface thereof, threads are formed to engage with threads formed at an inner surface of the tightening hole.

As illustrated in FIG. 7, the fixing portion 200 may further include at least one additional support member 230 that supports the hose H inserted into the insertion path 100 together with the first and second fixing members 210 and 220 to facilitate change in a forming process of the hose H, particularly, change of the bending segment (H-2) while preventing the hose H from separating.

For example, the additional support member 230 may include an installation piece 231, a lever 232, and a support piece 233 and may be provided with a plurality of configurations so as to support an outer surface of the straight segment (H-1) of each of the hoses H inserted into the insertion path 100 in order to satisfy the above-described merit.

The installation piece 231 is formed to have entirely a shape ‘¬’, a lower portion thereof is fixed to an outer surface of the insertion path 100, and in a horizontal upper portion, a pair of ribs for rotatably installing the lever 232 is protruded upward.

In this case, it is preferable that a vertical length of the installation piece 231 provided in the insertion path 100 is provided so that the support piece 233 to be described later rotates to be substantially perpendicular downward and has a height that may press not to make a change in a shape of the hose H when supporting the hose H by contact.

The lever 232 is formed to have an entirely inverted ‘Y’ shape, and a lower portion thereof may be rotatably and axially coupled to a pair of ribs to rotate the support piece 233 by the operator's external force.

A lower portion of the support piece 233 is axially coupled to rotate between the pair of ribs, and an upper portion thereof supports an outer surface of the hose H inserted into the insertion path 100 by rotation.

The support piece 233 has a structure that may rotate a lower portion thereof by a force of the lever 232 by contact when the lever 232 rotates downward, and when the lever 232 rotates in a reverse direction, the support piece 233 has a structure that may return to an original position by freely rotating in a reverse direction by an elastic restoring force of an electric body (not illustrated) such as a spring.

Hereinafter, an operation of a hose forming apparatus according to an embodiment of the present disclosure will be described in detail with reference to the accompanying drawings.

FIGS. 8 to 11 are views illustrating in order a state in which a hose is mounted using a hose forming apparatus according to the present disclosure.

First, as illustrated in FIG. 8, the front end of the tubular hose H having a shape ‘-’ before forming is inserted into the fixing body 212, and the hose H is coupled to the first fixing member 210 so that an outer surface of the tubular hose H is supported by the separation preventing pieces 213.

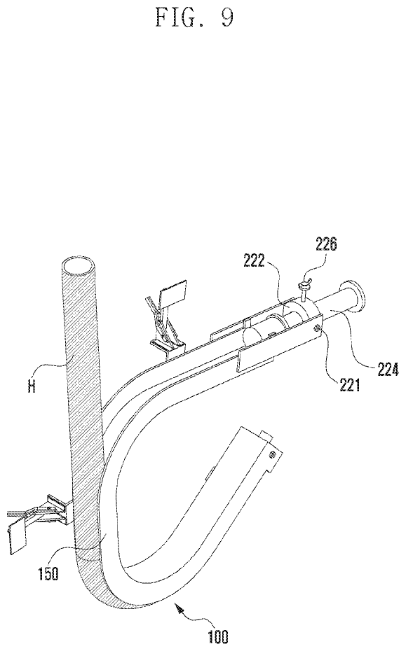

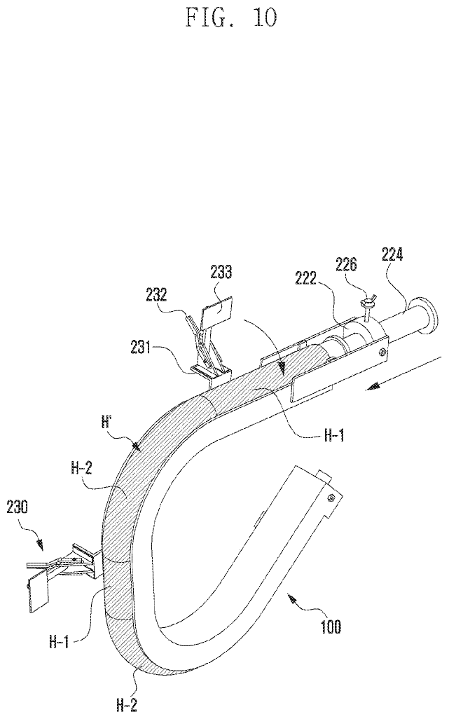

Next, as illustrated in FIGS. 9 and 10, the hose H is inserted into the insertion path 100 so that the straight segment (H-1) and the bending segment (H-2) of the hose H coupled to the first fixing member 210 correspond to the straight insertion portion 110 and the bending insertion portion 120 formed in the insertion path 100, and the rear end of the hose H may be positioned at the second fixing member 220.

Next, as illustrated in FIG. 10, by moving one end of the moving body 224 movably inserted into the penetration body 222 in a direction of the hose H, one end of the moving body 224 may be inserted into the hose H, and in this state, the pressure screw 226 is fastened and fixed to prevent a movement of the moving body 224.

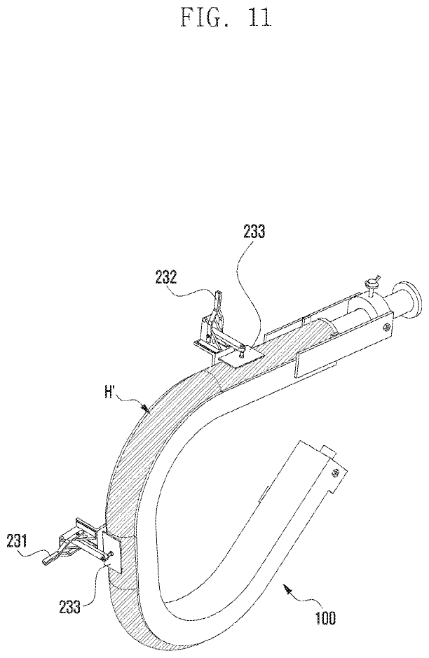

Finally, as illustrated in FIG. 11, each of the support pieces 233 of at least one additional support members 230 is rotated by the lever 232 to support an outer surface of the hose H exposed to an opened upper portion of the insertion path 100; thus, an operation of the hose forming apparatus 1 according to an embodiment of the present disclosure is finished, and when the hose H is separated, operations may be performed in the reverse order.

Further, the hose H coupled to the insertion path 100 by the above-described operation may be formed in a hose H in a desired shape of the operator through a forming process step.

As described above, unlike the prior art, in the hose forming apparatus 1 according to the present embodiment, when the hose H in which forming is complete by a forming process step is separated from the insertion path 100, the hose H can be integrally separated through an opened upper portion instead of a longitudinal direction of the insertion path 100, thereby minimizing a defective rate by deformation occurring upon separating.

Further, unlike the prior art, a diameter of the straight insertion path 100 of the insertion path 100 and a diameter of the curved insertion path 100 thereof are formed differently according to an outer diameter of the hose H to be formed; thus, in a forming process step, it is possible to easily correspond to deformation of the hose H.

Further, unlike the prior art, it is possible to easily separate the hose H in which forming is complete by the fixing portion 200 including a first fixing member 210 in which the hose H is inserted into and fixed to the lower end of the insertion path 100 and a second fixing member 220 provided to perform a reciprocating motion at the upper end of the insertion path 100 to fix the hose H.

According to the present disclosure, unlike the prior art, by separating integrally a hose through an opened upper portion instead of a longitudinal direction of an insertion path when separating the hose in which forming is complete by a forming process step from the insertion path, a defective rate by deformation occurring when separating the hose can be minimized.

Further, unlike the prior art, by differently forming diameters of a straight insertion path and a curved insertion path of the insertion path according to an outer diameter of the hose to be formed, it is possible to easily correspond to deformation of the hose at a forming process step.

Further, unlike the prior art, the hose can be easily separated in which forming is complete by a fixing portion including a first fixing member in which the hose is inserted into and fixed to the lower end of the insertion path and a second fixing member provided to perform a reciprocation motion at the upper end of the insertion path to fix the hose.

Although embodiments of the present disclosure have been described in detail hereinabove, it should be clearly understood that many variations and modifications of the basic inventive concepts herein described, which may appear to those skilled in the art, will still fall within the spirit and scope of the embodiments of the present disclosure as defined in the appended claims.

What is claimed is:

1. A hose shaping apparatus, comprising:
an insertion path configured to insert a hose in a longitudinal direction and to have a shape corresponding to that of the hose to be formed; and
a fixing portion configured to fix the hose inserted into the insertion path,
wherein the insertion path forms a straight insertion portion configured to insert a straight segment of the hose to be formed and a bending insertion portion configured to insert a bending segment of the hose, and the bending insertion portion has an additional angle further bent by 15 to 35° than an angle of the bending segment.

2. The hose shaping apparatus of claim 1, wherein an inner diameter of the straight insertion portion is larger by 1 to 5 mm than an outer diameter of the hose, and an inner diameter of the bending insertion portion is larger by 3 to 7 mm than an outer diameter of the hose.

3. The hose shaping apparatus of claim 1, wherein the fixing portion comprises a first fixing member configured to fix the front end of the hose inserted into the insertion path and a second fixing member configured to fix the rear end of the hose.

4. The hose shaping apparatus of claim 3, wherein the first fixing member comprises a fixing body fixed by a first setscrew provided at one end of the insertion path and in which one end of the hose is inserted in a fitting manner for shape matching, and a separation preventing piece formed in an upper portion of the insertion path to be adjacent to the fixing body and configured to support an outer surface of the hose inserted into the fixing body to prevent the hose from deviating when coupling the hose inserted into the fixing body to the second fixing member,
wherein the second fixing member comprises a penetration body fixed by a second setscrew provided at the other end of the insertion path and having a penetration hole having connected both ends, a moving body slidably inserted into the penetration hole and into which the other end of the hose is inserted in a fitting manner for shape matching, and a pressure screw configured to advance from an outer surface of the moving body into the penetration hole so as to fix by a pressure an outer surface of the moving body inserted into the penetration body, and
wherein the moving body further has at least one stopper to limit a moving distance of the moving body or to limit an insertion length of the hose inserted into the moving body.

5. The hose shaping apparatus of claim 3, wherein the fixing portion further comprises an additional support member provided adjacent to each other in a longitudinal direction of the insertion path to support the hose together with the first fixing member and the second fixing member, and
wherein the additional support member comprises an installation piece fixedly installed in an upper portion of the insertion path, a lever rotatably coupled to the installation piece, and a support piece having a plate shape and configured to support an upper surface of the hose inserted into the insertion path by a rotation of the lever.
